(19) United States
(12) Patent Application Publication
(10) Pub. No.: US 2015/0100337 A1
(43) Pub. Date: Apr. 9, 2015

(54) HEALTHCARE SERVICE MARKETPLACE SYSTEM AND METHOD

(71) Applicant: POKITDOK, INC., San Mateo, CA (US)

(72) Inventors: Ted TANNER, San Mateo, CA (US); Lisa MAKI, San Mateo, CA (US); Thomas CRAMER, San Mateo, CA (US); Doug THOMAS, San Mateo, CA (US); Brian CORBIN, San Mateo, CA (US)

(73) Assignee: PokitDok, Inc.

(21) Appl. No.: 14/460,898

(22) Filed: Aug. 15, 2014

Related U.S. Application Data
(60) Provisional application No. 61/887,904, filed on Oct. 7, 2013.

(51) Int. Cl. G06Q 50/22; G06Q 50/00; G06Q 30/06

(52) U.S. Cl. CPC G06Q 50/22; G06Q 30/0611; G06Q 30/0631; G06Q 50/01
USPC 705/2

(57) ABSTRACT

A healthcare service marketplace system and method are provided. The system may generate a healthstream for a user that provides a more complete view of health related events. The system may also provide a transparent health marketplace with clear service descriptions and posted prices.

### PRIORITY CLAIMS/RELATED APPLICATIONS

This application claims the benefit under 35 USC 119(e) and 35 USC 120 to U.S. Provisional Patent Application Ser. No. 61/887,904 filed on Oct. 7, 2013 and entitled “Healthcare Service Marketplace System and Method”, the entirety of which is incorporated herein by reference.

### FIELD

The disclosure relates generally to a system and method for healthcare services marketplace.

### BACKGROUND

A lot of important health information is stored in different, distinct public and private systems. The challenge is that these distinct systems do not communicate at all with each other or do not have common data formats. As a result, while there is a lot health information, it is not readable accessible or unified in a manner to make it more useful. It is desirable to provide a system that unifies these distinct public and private health information systems and it is to this end that the disclosure is directed.

### BRIEF DESCRIPTION OF THE DRAWINGS

FIG. 1 illustrates an example of an implementation of a healthcare services marketplace system;

FIGS. 2 and 3 illustrate a method for providing a healthstream;

FIG. 4 illustrates an example of a user interface of the healthcare services marketplace system for posting to a timeline owned by the current user;

FIG. 5 illustrates an example of a user interface of the healthcare services marketplace system for tagging timeline posts;

FIGS. 6 and 7 illustrate an example of a user interface of the healthcare services marketplace system for privacy settings for timeline posts;

FIG. 8 illustrates an example of a user interface of the healthcare services marketplace system for viewing shared public healthstream posts from another user;

FIG. 9 illustrates an example of a user interface of the healthcare services marketplace system for a dashboard;

FIG. 10 illustrates an example of a profile user interface of the healthcare services marketplace system;

FIG. 11 illustrates an example of an add person user interface of the healthcare services marketplace system that allows a user to control who may access their profile data;

FIG. 12 illustrates an example of an add condition user interface of the healthcare services marketplace system;

FIG. 13 illustrates an example of a profile address edit user interface of the healthcare services marketplace system;

FIG. 14 illustrates an example of a shared public profile view user interface of the healthcare services marketplace system;

FIG. 15 illustrates an example of a people view user interface of the healthcare services marketplace system that enables discovery of people in the marketplace;

FIGS. 16-18 illustrate an example of a people detail view user interface of the healthcare services marketplace system;

FIGS. 19-20 illustrate an example of a find people user interface of the healthcare services marketplace system;

FIG. 21 illustrates an example of an email invite user interface of the healthcare services marketplace system;

FIG. 22 illustrates an example of a latest services user interface of the healthcare services marketplace system;

FIG. 23 illustrates an example of a service detail user interface of the healthcare services marketplace system;

FIG. 24 illustrates an example of a general settings user interface of the healthcare services marketplace system; and

FIG. 25 illustrates an example of a database schema for the healthcare services marketplace system.

### DETAILED DESCRIPTION OF ONE OR MORE EMBODIMENTS

The disclosure is particularly applicable to a web based healthcare service marketplace system and it is in this context that the disclosure will be described. It will be appreciated, however, that the system and method has greater utility.

The healthcare service marketplace system may unify the health information from different and distinct health systems into cases that are readily available to healthcare providers and approved family members/friends. Furthermore, Facebook posts, tweets, Foursquare check-ins, youtube videos and photos from flickr can provide important information about an ongoing health related matter. The system that may easily track health related events enables a stronger patient-provider relationship. A complete healthstream can often help avoid expensive tests and procedures. Patients are also given the option to anonymously share their healthstream events and cases to help educate others about cost effective treatment options.

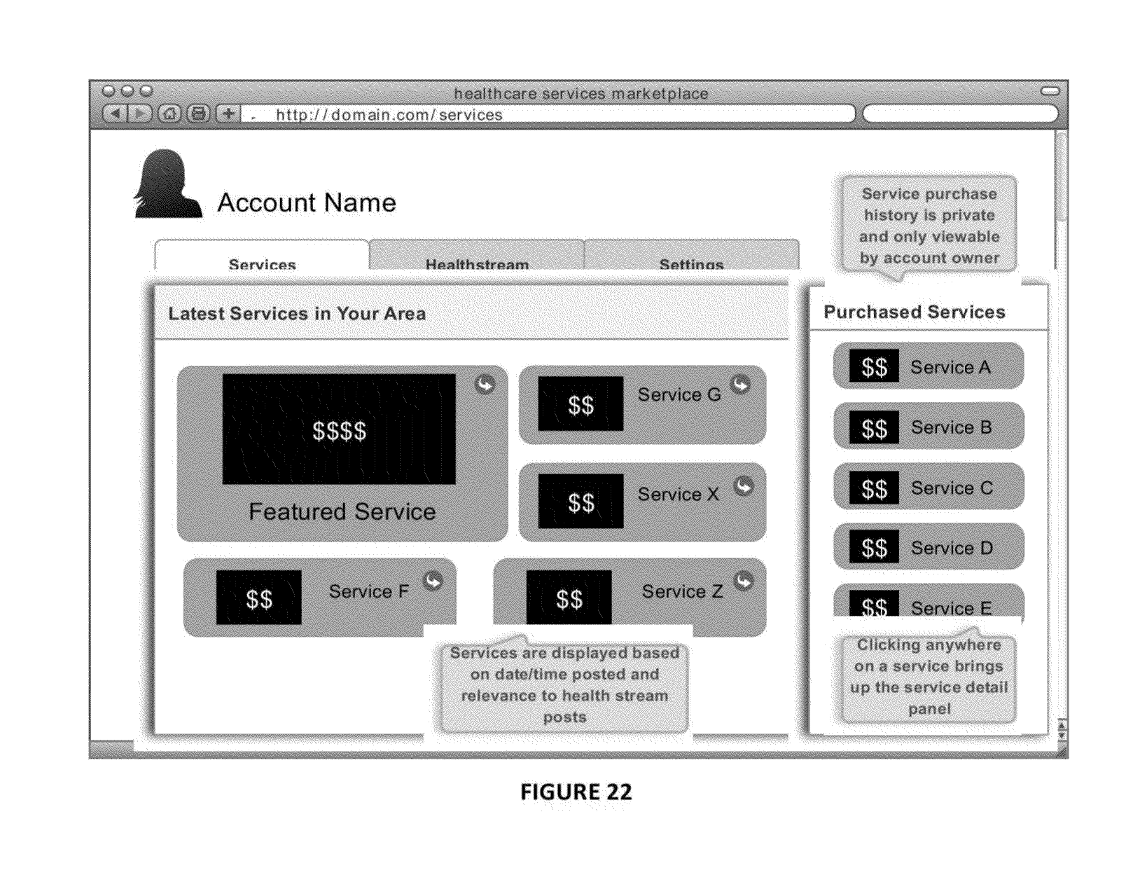

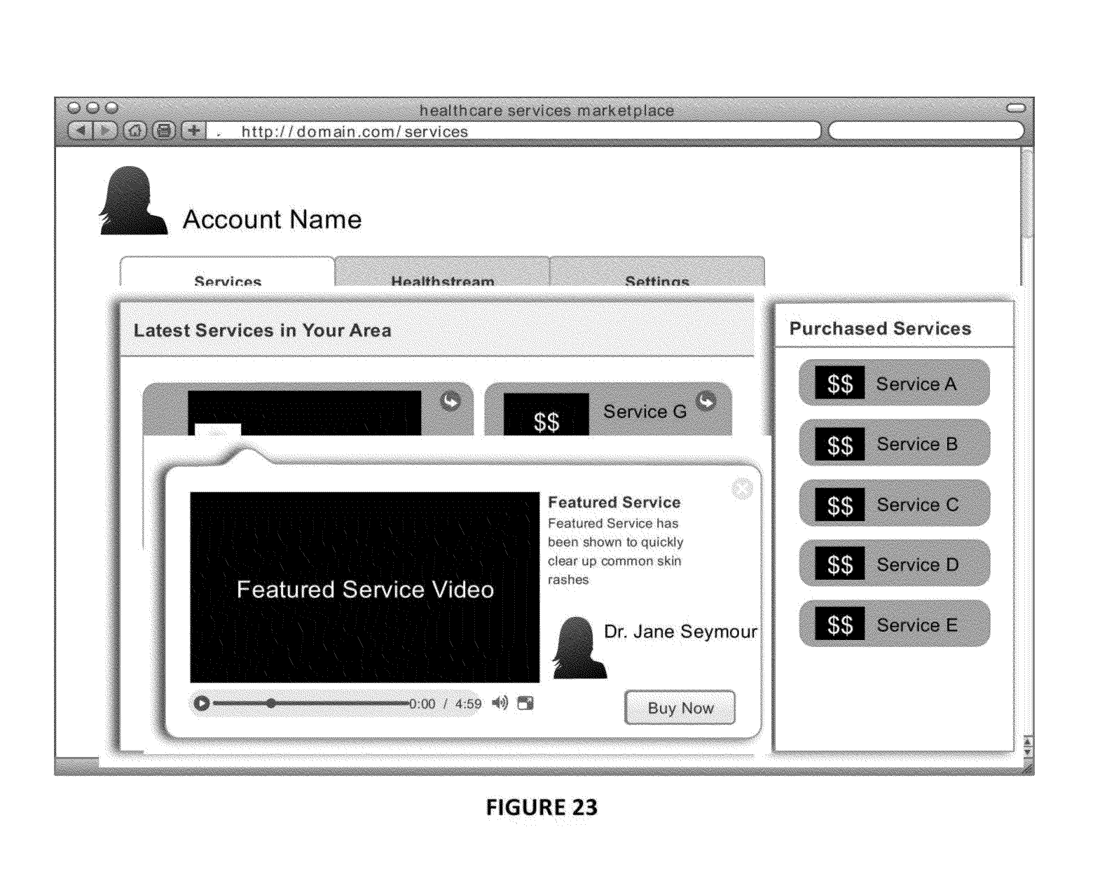

The healthcare service marketplace system, and the healthstream generated by the system, provides a more complete view of health related events. The system provides a transparent health marketplace with clear service descriptions and posted prices. FIGS. 22-23 illustrate how health services are presented with descriptions, price information and media based on a user's healthstream posts and profile information. The healthstream gives providers more information about a consumer's history. This information can then be used to better recommend services related to a consumer's quote request(s), such as using the request for quote system. When healthstream data is anonymously shared within the community of the system, it can help others find services with posted prices that may be of help to them based on their recent healthstream entries. The shared healthstream data also may help enable service discovery within the marketplace.

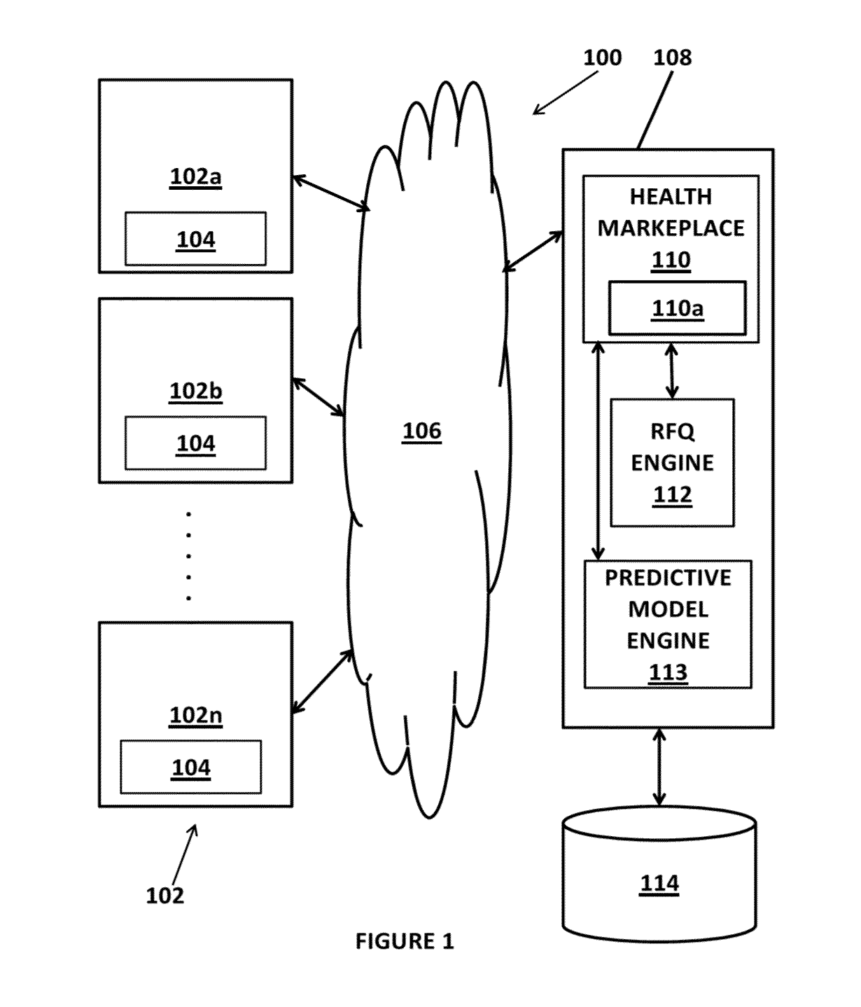

FIG. 1 illustrates an example of an implementation of a healthcare services marketplace system 100 that may generate a healthstream. The healthcare marketplace system 100 may have one or more computing devices 102 that connect over a communication path 106 to a backend system 108. Each computing device 102, such as computing devices 102a, 102b, . . . , 102n as shown in FIG. 1, may be a processor based device with memory, persistent storage, wired or wireless communication circuits and a display that allows each computing device to connect to and couple over the communication path 106 to a backend system 108. For example, each computing device may be a smartphone device, such as an Apple Computer product, Android OS based product, etc., a tablet computer, a personal computer, a terminal device, a laptop computer and the like. In one embodiment shown in FIG. 1, each computing device 102 may store an application 104 in memory and then execute that application using the processor of the computing device to interface with the backend system. For example, the application may be a typical browser application or may be a mobile application. The communication path 106 may be a wired or wireless communication path that uses a secure protocol or an unsecure protocol. For example, the communication path 106 may be the Internet, Ethernet, a wireless data network, a cellular digital data network, a WiFi network and the like.

The backend system 108 may also have a health marketplace engine 110, a request for quote engine 112 and a predictive pricing engine 113 that may be coupled together. Each of these components of the backend system may be implemented using one or more computing resources, such as one or more server computers, one or more cloud computing resources and the like. In one embodiment, the health marketplace engine 110, the request for quote engine 112 and the predictive modeling engine 113 may each be implemented in software in which each has a plurality of lines of computer code that are executed by a processor of the one or more computing resources of the backend system. In other embodiments, each of the health marketplace engine 110, the request for quote engine 112 and the predictive modeling engine 113 may be implemented in hardware such as a programmed logic device, a programmed processor or microcontroller and the like. The backend system 108 may be coupled to a store 114 that stores the various data and software modules that make up the healthcare system. The store 114 may be implemented as a hardware database system, a software database system or any other storage system.

The health marketplace engine 110 may allow practitioners that have joined the healthcare social community to reach potential clients in ways unimaginable even a few years ago. In addition to giving practitioners a social portal with which to communicate and market themselves with consumers, the marketplace gives each healthcare practitioner the ability to offer their services in an environment that is familiar to users of Groupon, Living Social, or other social marketplaces.

The request for quote engine 112, in the example shown in FIG. 1 in which the request for quote engine 112 is part of the health marketplace system 110, allows a user of the health marketplace system to search for practitioners in their area that treat their conditions or practice in a desired specialty and request a quote for the service they need. Further details of the request for quote engine 112 are provided in U.S. Patent Application Ser. No. 61/871,195, filed on Aug. 28, 2013 and U.S. patent application Ser. No. 14/328,591 filed on Jul. 10, 2014, the entirety of both of which are incorporated herein by reference. The predictive modeling engine 113 may generate healthcare service prices based on predictive modeling. Further details of the predictive modeling engine 113 are provided in U.S. Patent Application Ser. No. 61/881,918, filed on Sep. 24, 2013 and U.S. patent application Ser. No. 14/455,341 filed on August 8, 2014, the entirety of both of which are incorporated herein by reference.

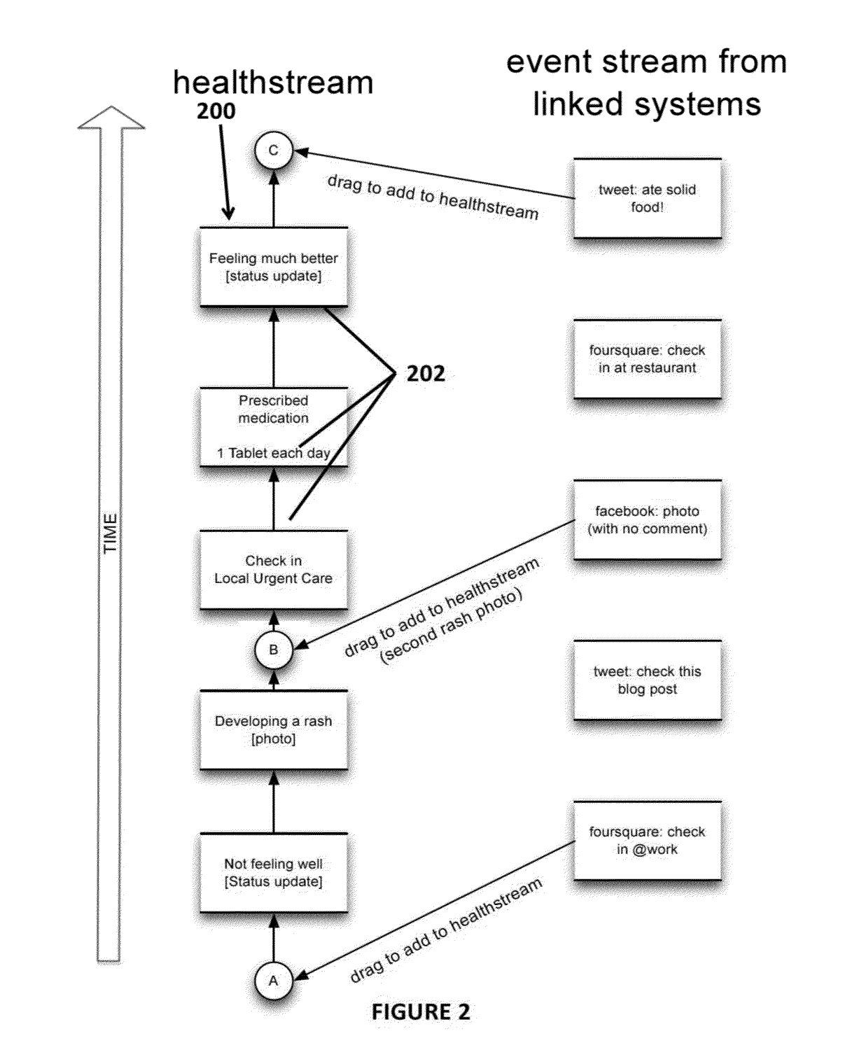

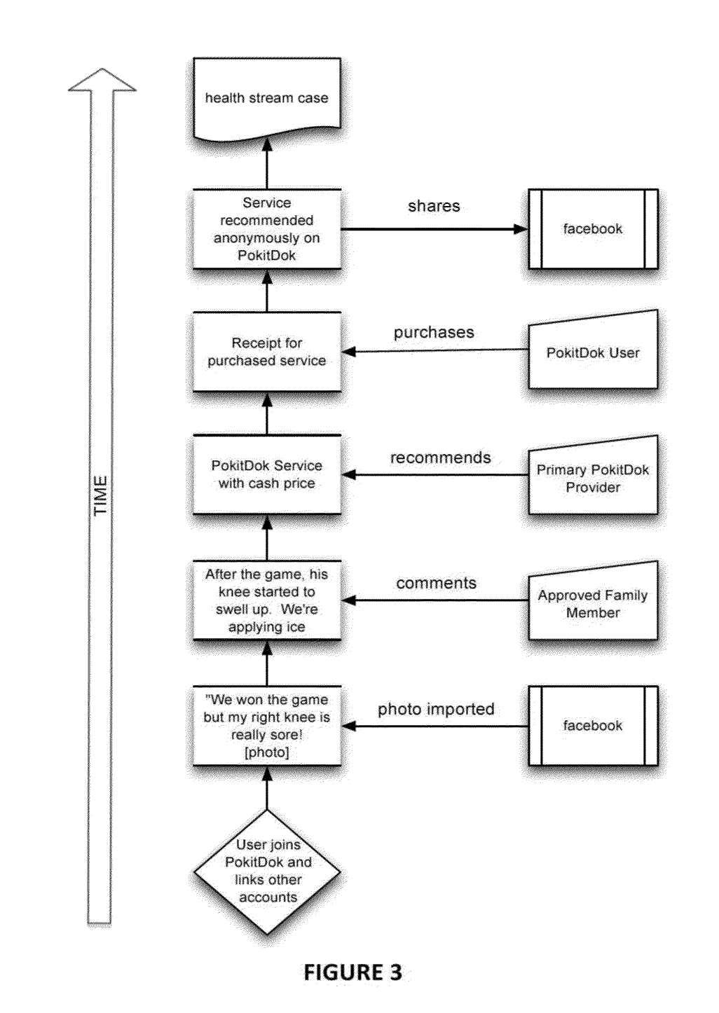

The health marketplace system 110 may further have a health management engine 110a that may generate a healthstream for each member who is a user of the health system 100 and who has logged into the health system 100. The health management engine 110a and its functions described below may be implemented by a processor of the computing resources described above that is configured to perform the operations to the healthstream as described below. To perform the below operations, the health management engine 110a may further comprise a healthstream generator unit that processes the health related data and generates the healthstream, a third party unit that, using the APIs of the third party systems, imports the health related data of the user from the third party system and a user interface unit that generates the healthstream timeline user interface (an example of which is shown in FIGS. 2-3) as well as the other user interfaces of the system as described below.

The healthstream groups health related information and events into a timeline that can be shared among a patient, healthcare provider(s), and approved family members/friends of each member/user of the system. The information for each user/member may be entered directly into the healthstream using the application 104. Alternatively or in addition, the information about the user/member may also be imported from entries made in other systems including a social networking system, such as Facebook®, a communications system, such as Twitter®, a system with check-ins, such as Foursquare® and other web sites. Although the keeping of a detailed health journal requires a lot of discipline and work and busy lives don't often have time to keep up with it, a lot of important health information about the user/member may be recorded all the time in social networks and web sites. The healthstream may provide users an easy way to import and organize information that has already been recorded in these other systems so that it can be visualized as a timeline of health information.

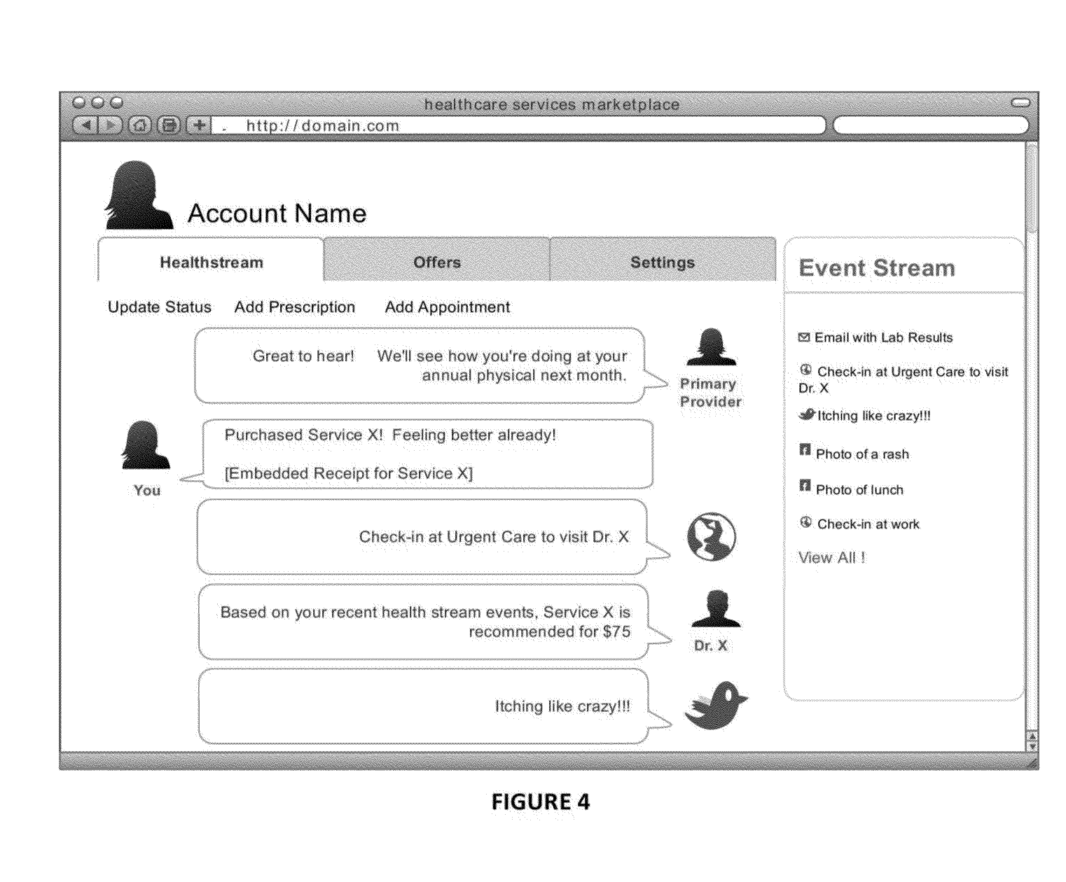

The health timeline (that is part of the healthstream), examples of the user interface of which are shown in FIGS. 4-8, may always be available for review by approved members of the PokitDok community (healthcare providers, family members, friends) who have the required access rights and privileges that may be set up by the user. The underlying authorizations can be any method that allows for data access as an opt-in process. Manually setting these priviledges may be the default behavior.

The system may allow a user/member to link an account in the health system, such as the health system provided by PokitDok, with other accounts that have been established by the user/member using a known OAuth authorization flow (further details of which may be found at http://en.wikipedia.org/wikiiOAuth which is incorporated herein by reference.) The OAuth flow links the accounts of the user (social network and web accounts) so that the system is able to gather health related information. Once the accounts are linked, the application 104 on the computing device may make API calls to each linked system to import health related posts into their healthstream. To determine which posts are health related, the system may parse each post and search for basic key words or even term frequency co-occurrences as well as crawling the profiles and information streams of the users whereas they are op-ting into the login into the system. Alternatively, the system may use well-known clustering around term frequency-inverse document frequency (tf-idf). For example, an example of an implementation of the above technique may be found at http://www.elasticsearch.org/guide/en/elasticsearch/reference/current/query-dsl-mlt-query.html that is incorporated herein by reference.

This login gives the system access to the respective users information. In addition, users may be able to drag and drop entries to and from their healthstream to quickly manage what's permanently stored there as described below in more detail with reference to FIG. 2.

In the health system, the timeline view generated for each user/member may support multiple cases in the timeline view. Each case may be like a directory on a filesystem where events may be stored together. For example, a mother may have cases defined for herself and for her young children that are not yet old enough to manage their own healthstream. When that mother uses the PokitDok healthstream, her checkins at the doctor's office will be imported into her case folder. When she posts about her child running a fever on facebook, that event will be imported into her child's case folder that may be done by utilizing the APIs provided by the various social networks and systems that can be linked to a PokitDok account. Each time a PokitDok user returns to the system, asynchronous tasks are queued to process the latest data from their linked accounts. The results of the above tasks may be presented in a list in the application. Each entry in that list may be manually added to a case using the drag and drop capabilities of HTML5. In addition, when possible, imported entries may be automatically added to cases by analyzing the imported content for health related keywords. For example, the keywords, key terms, key phrases, symptoms, or procesures can be of the kind but not limited to fever, pain, doctor, ACA, Obamacare, etc and anything that is health related as the system can link together the meanings via a graph inferred topology/medical type taxonomy much like DBPedia, MeSH (www.nlm.nih.gov/mesh/) may be used. For example, see http://dbpedia.org/About or http://www.ncbi.nlm.nih.gov/pmc/articles/PMC3245088/ for content references that allow for linked data mechanisms in this area. For example below is a piece of content that could be easily pulled into a health stream if the user selects the subject heart disease:

Aug 10—Increased #physicalactivity reduces heart disease risk, revs up energy, and improves your mood: http://owl.li/zG4BU #getmoving

The health system may support a variety of healthstream entry types. For example, when a checkin is added to the healthstream, a link to the location is stored along with geolocation information so it can be quickly displayed on a map view. As another example, when entries with photos are added to the healthstream, a link to the original photo is stored along with cached versions of the photo at various resolutions for display in different contexts. The healthstream may also include entries about medications that may be added to the timeline that include information about when a medication was started/stopped along with dosage details for the medication. In addition, doctor appointments may also be added to the healthstream. Furthermore, healthstream video entries contain links to the original video so that it may be embedded in the health timeline along with the other information. In addition to the specific healthstream entry types above, a generic entry type may be available that supports miscellaneous file attachments. For example, a user may have a PDF of blood results that were emailed to them that they want to add to their healthstream so that it can be shared with other health providers also on that case. The healthstream may allow a user to drag the PDF attachment from their email to the appropriate case in their timeline.

In the system 100, each of the entries for a user may be stored in the store 114 with a user's globally unique identifier and the identifiers of other PokitDok users that are allowed to view the information to provide, among other things, access control for the data in the healthstream of each user. In the system, each entry may default to being private among the users explicitly specified on the data. Users can choose to change the privacy level to ‘anonymous’ when they want to share information they've learned about a particular health issue with the community without revealing their identity.

Healthcare providers that are part of a healthstream case for a user can also add events to it. For example, a provider can review a user's healthstream when meeting with them and recommend a service they've posted on the health marketplace as part of their treatment plan.

This may add that service to the healthstream with a date/time stamp so the patient and other healthcare providers are all up-to-date with currently active treatments and medications. If multiple providers are participating on a case, email and short message system (SMS) alerts can be triggered to alert them that new information is available for their review.

FIGS. 2 and 3 illustrate a method for providing a healthstream. FIG. 2 shows drag and drop management with a healthstream 200 of a user. As shown in FIG. 2, an example of the healthstream of the user may have one or more entries 202 that occur during a time period for the user. As shown in FIG. 2, the entries may be a status update, a photo, a check in to urgent care and a prescribed medication. As described above, the healthstream may include entries/events from one or more linked systems. For example, as shown in FIG. 2, the linked systems may be Twitter (tweet messages), foursquare (check-ins), Facebook (photos or messages) and the like. Furthermore, the system 100 allows the user to drag and drop the linked system events into the healthstream of the user. FIG. 3 illustrates another example of a healthstream with entries being generated by members (approved family member, primary health care provider, approved purchase service) and linked services (Facebook in the example in FIG. 3.)

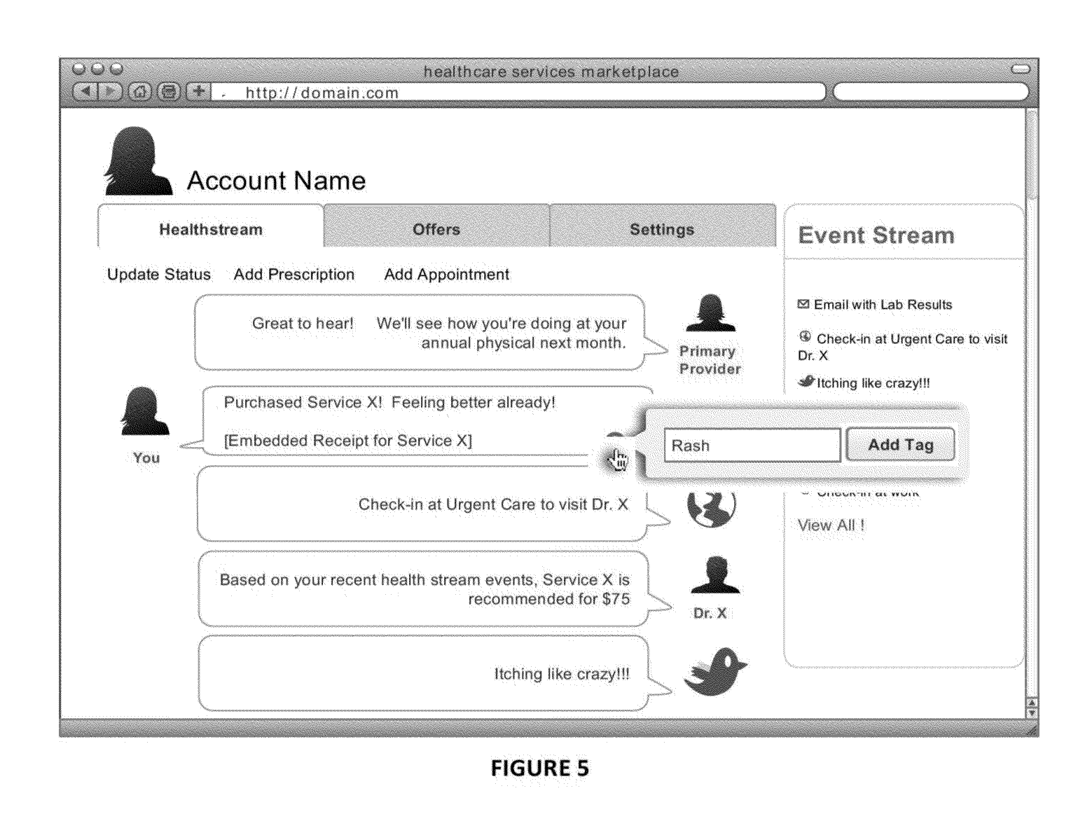

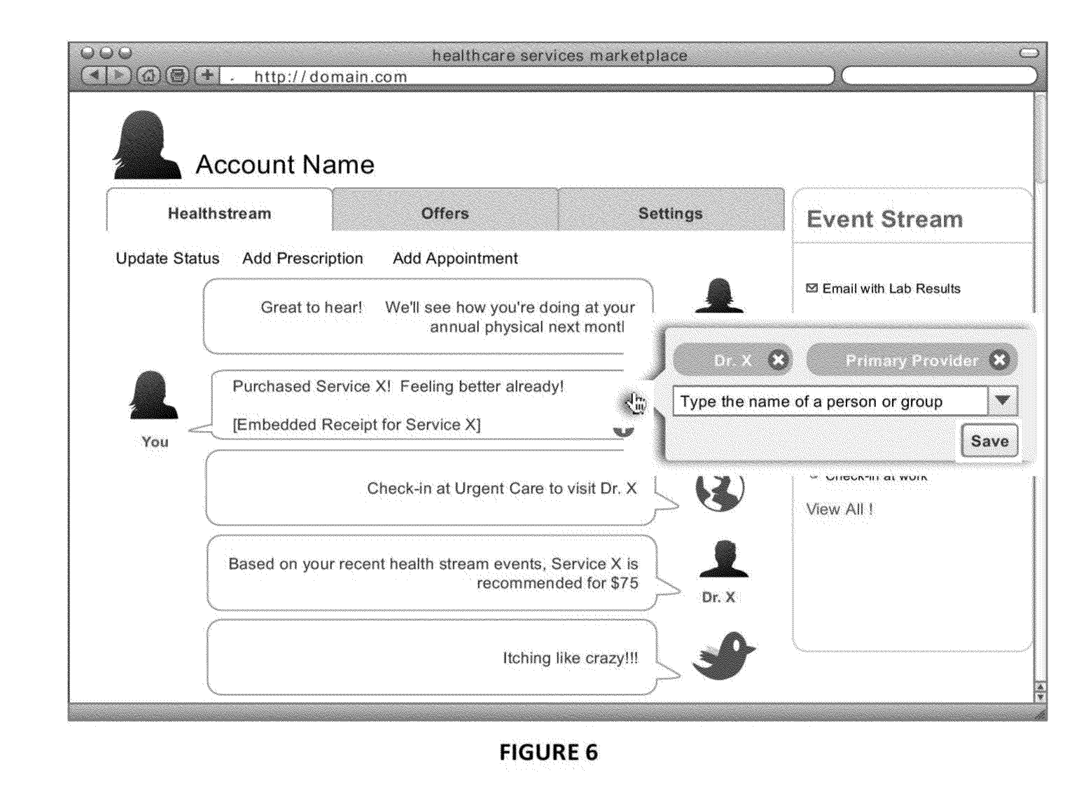

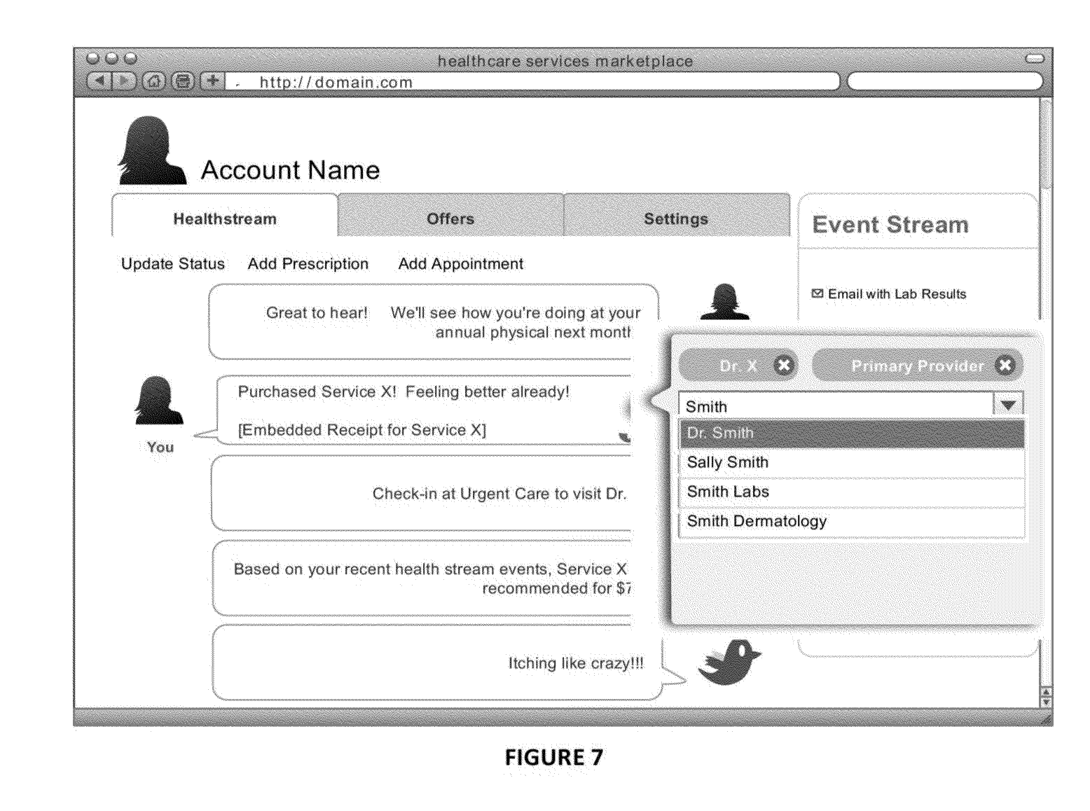

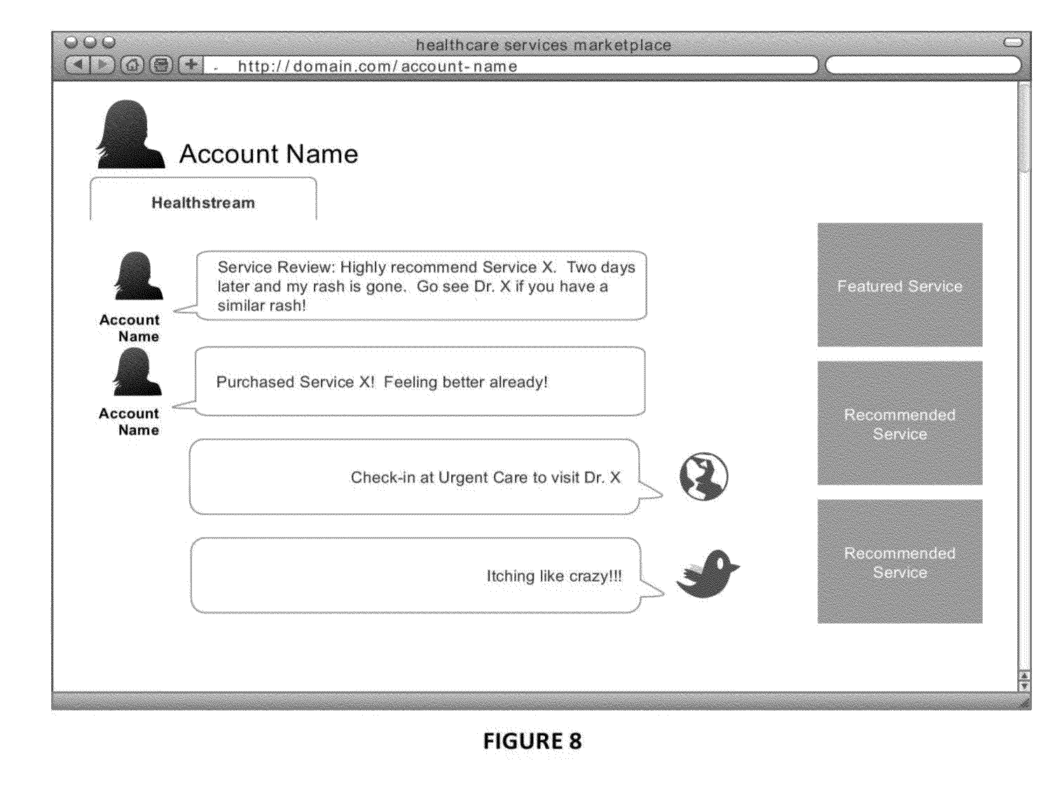

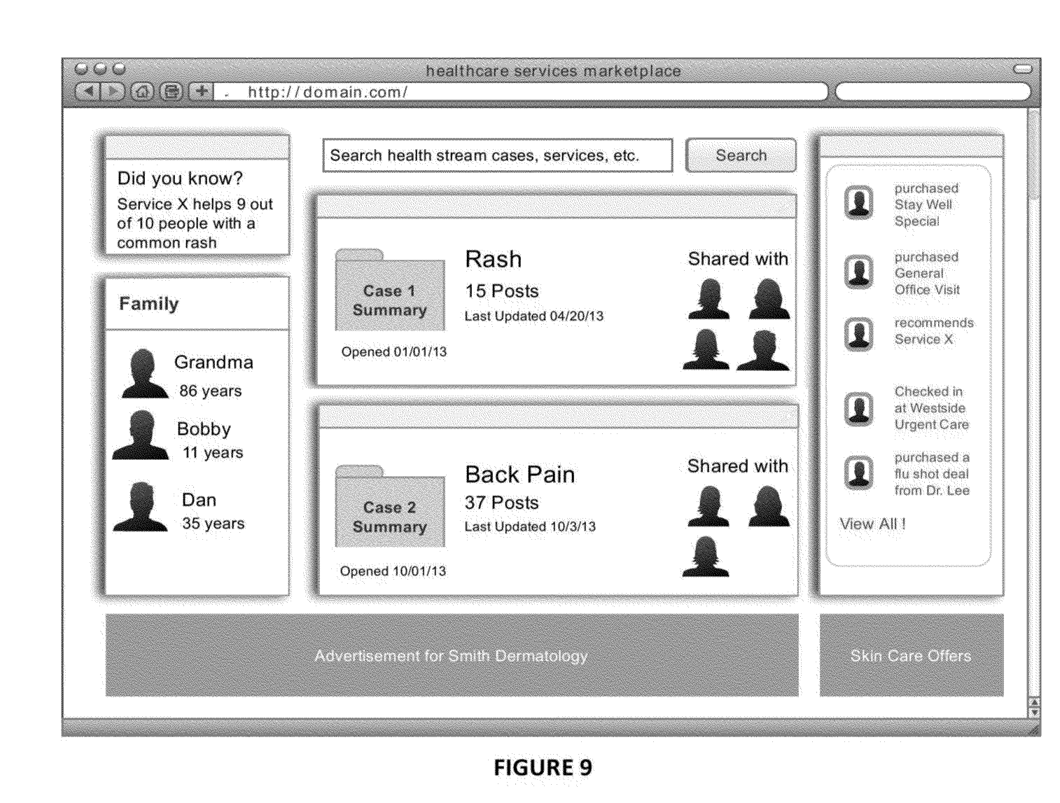

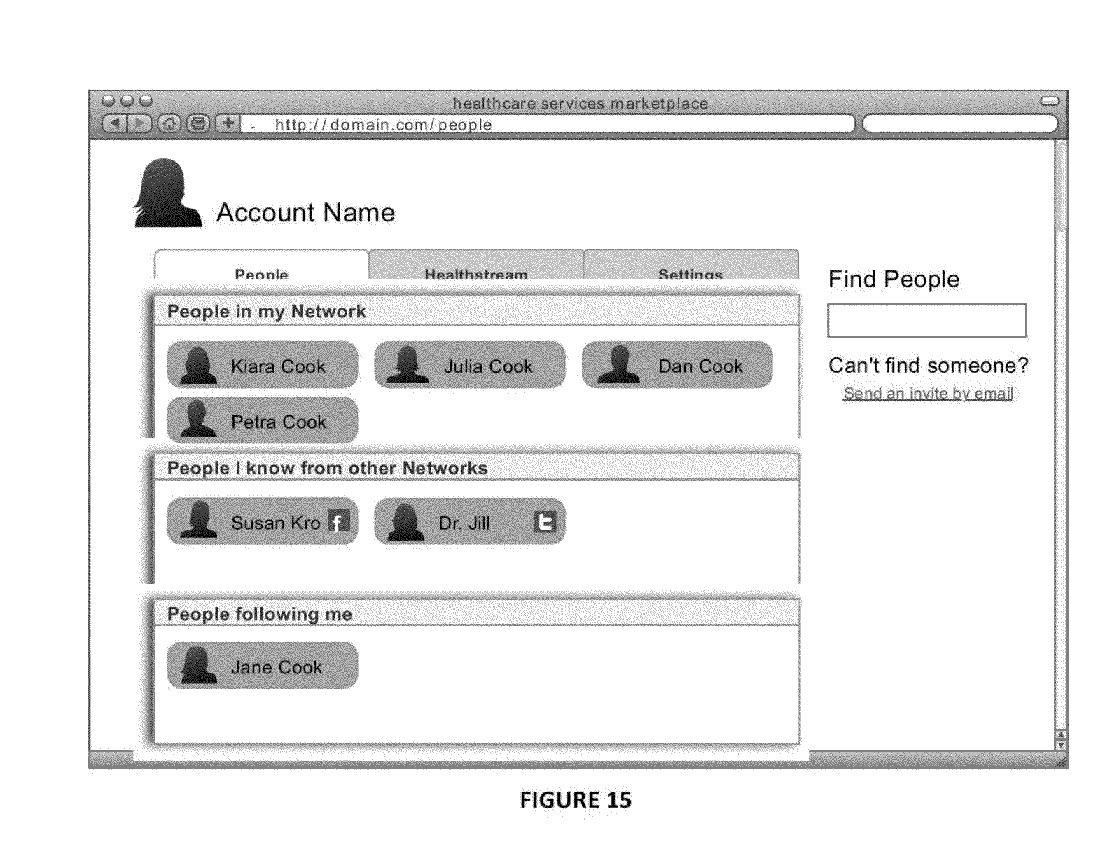

FIG. 4 illustrates an example of a user interface of the healthcare services marketplace system for posting a timeline own view (the healthstream of the user) by a user and FIG. 5 illustrates an example of a user interface of the healthcare services marketplace system in which a user can add a new tag in the timeline posts. FIGS. 6 and 7 illustrate an example of a user interface of the healthcare services marketplace system for privacy settings for timeline posts in which the user can adjust the access control lists for the timeline of the user. FIG. 8 illustrates an example of a user interface of the healthcare services marketplace system for shared public views in the timeline posts in which only public posts/entries or entries/posts shared with the viewer (who in viewing the healthstream of a different user) are shown based on the access control settings. FIG. 9 illustrates an example of a user interface of the healthcare services marketplace system for a dashboard that displays views of the cases for the user (influenza, backache and sleep apnea for example) that are associated with a particular user. FIG. 15 also illustrates an example of the case view for a user.

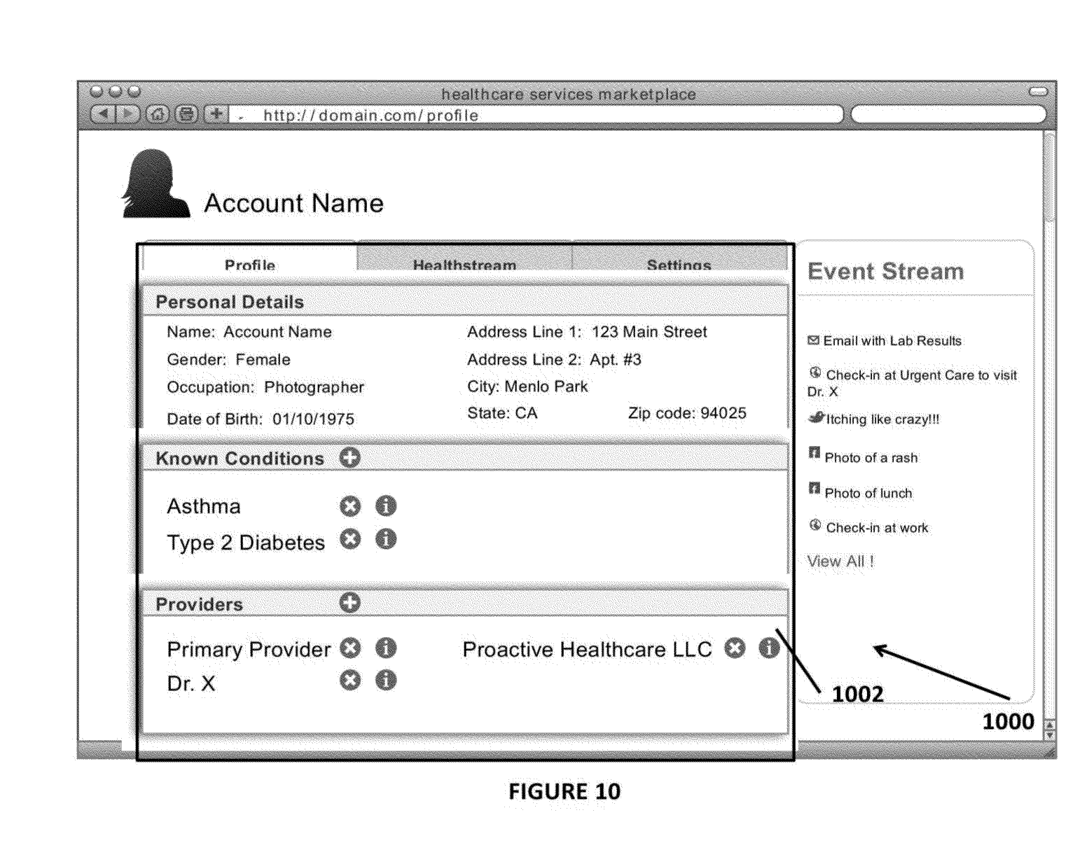

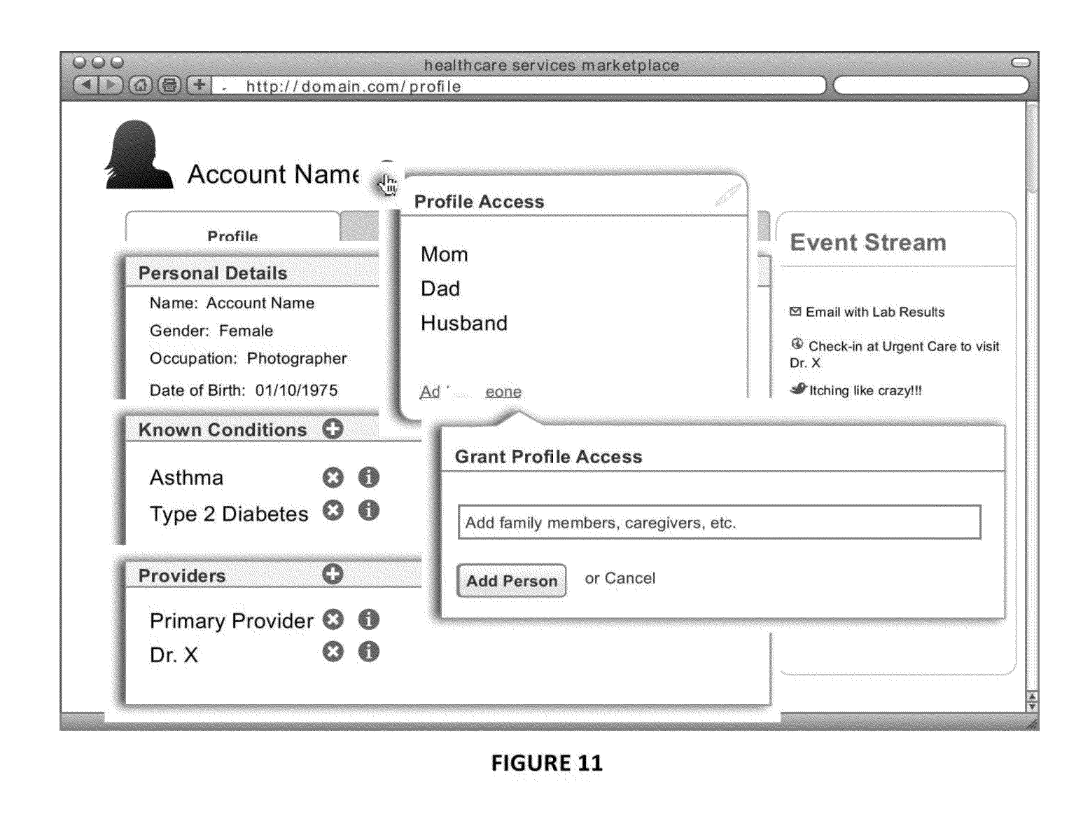

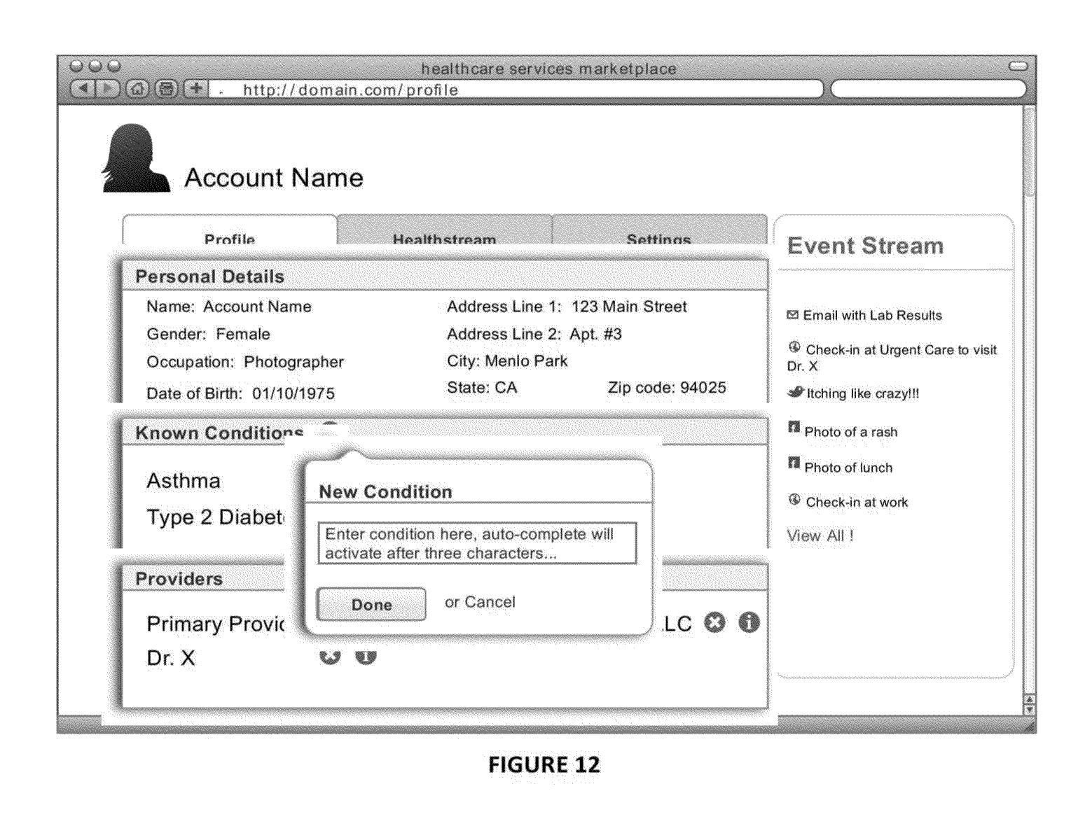

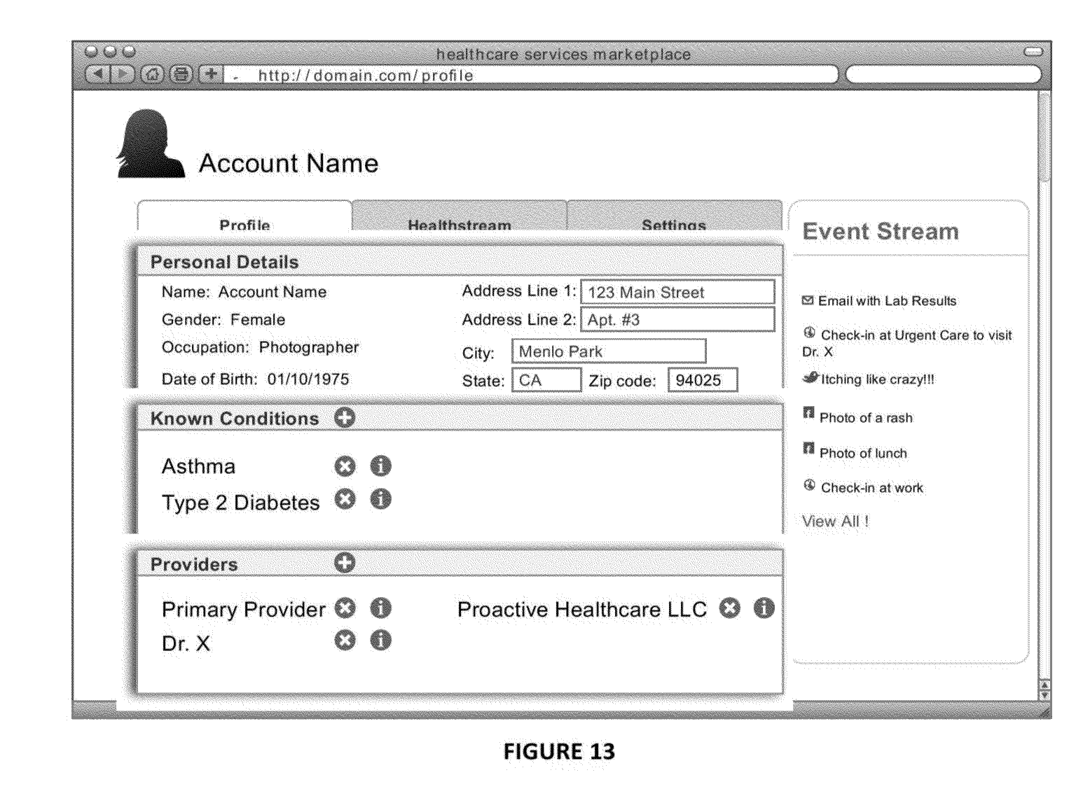

FIG. 10 illustrates an example of an account profile user interface 1000 of the healthcare services marketplace system. The user interface may have a personal details portion 1002 that displays the personal details of the particular user. For example, as shown in FIG. 10, the personal details may include an address/location, one or more known conditions, and one or more healthcare providers (practitioners) associated with the user. As shown in FIGS. 10 and 11, the known conditions portion and the healthcare provider portion allow the user to add additional information. For example, FIG. 12 shows a user interface to add a condition while FIG. 13 shows an interface to edit an address in the system. In addition, as shown in FIG. 11, the system allows the user to add more people who are authorized to view and/or interact with the healthstream of the user.

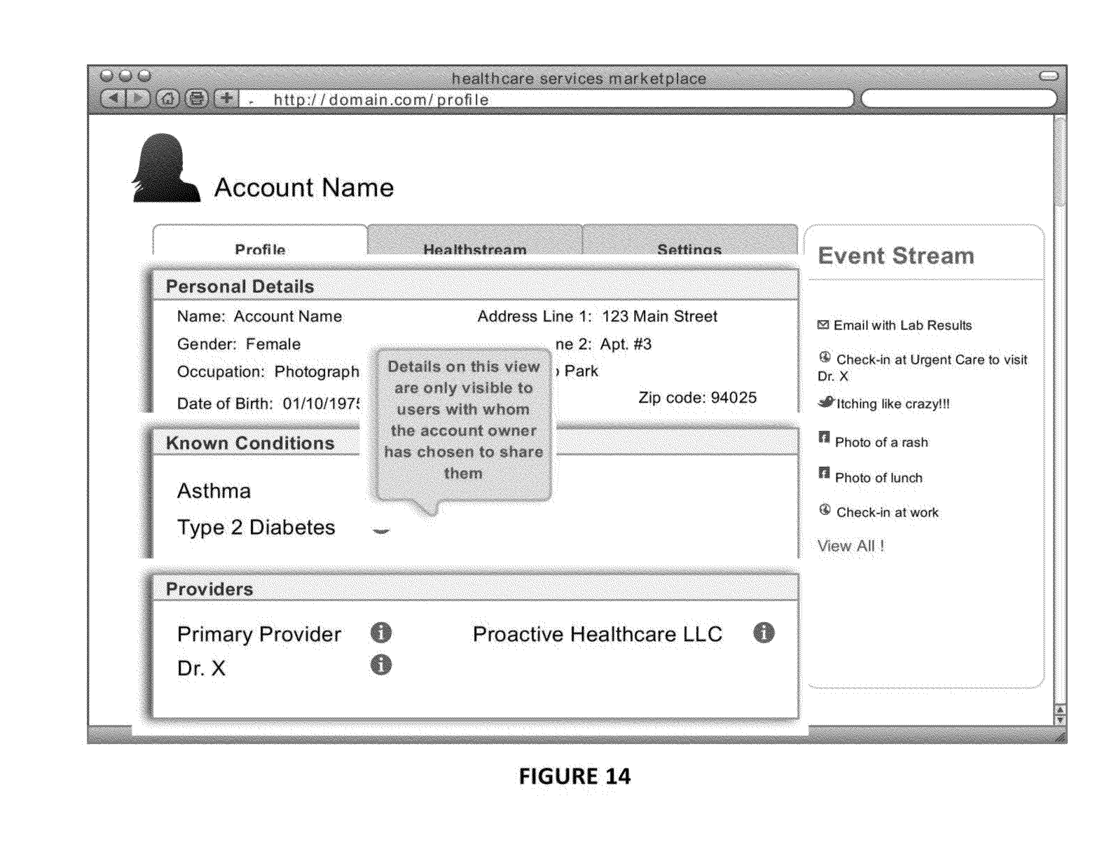

FIG. 14 illustrates an example of a shared public view user interface of the healthcare services marketplace system that is a view of the user that may be seen by users of the system who have access rights (sharing) to the profile of the user.

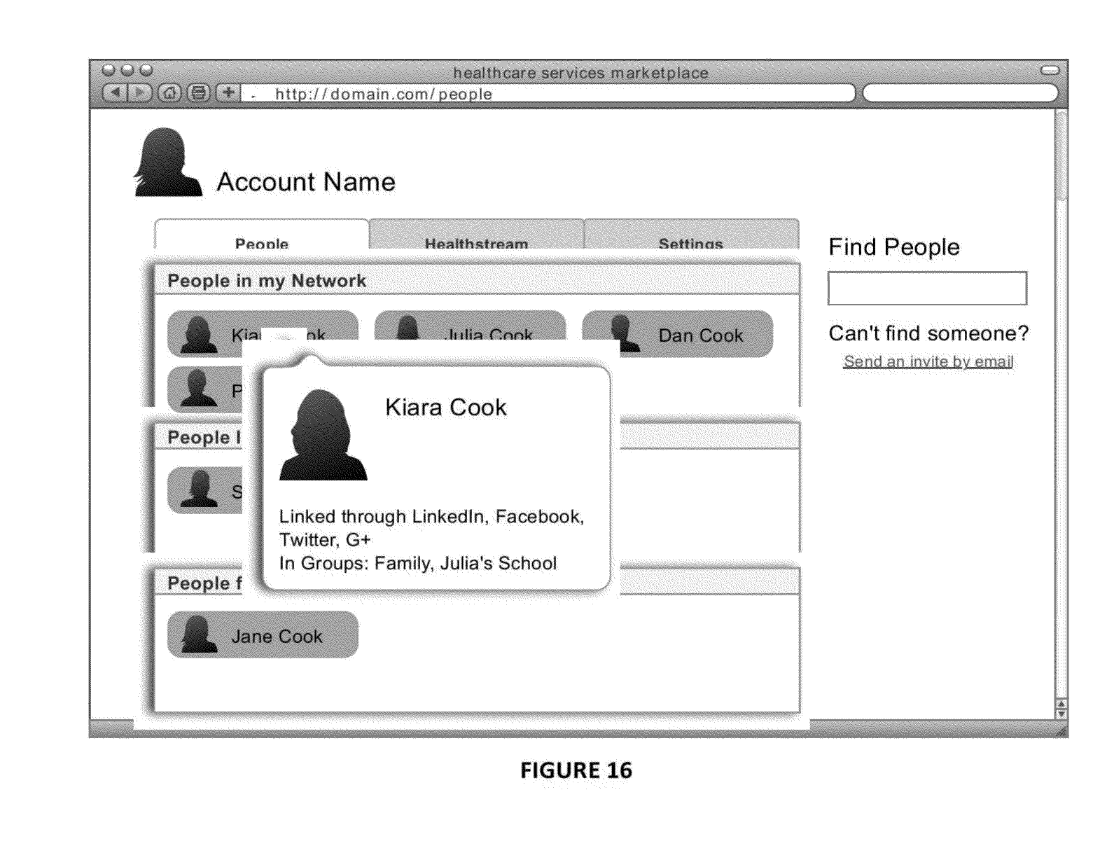

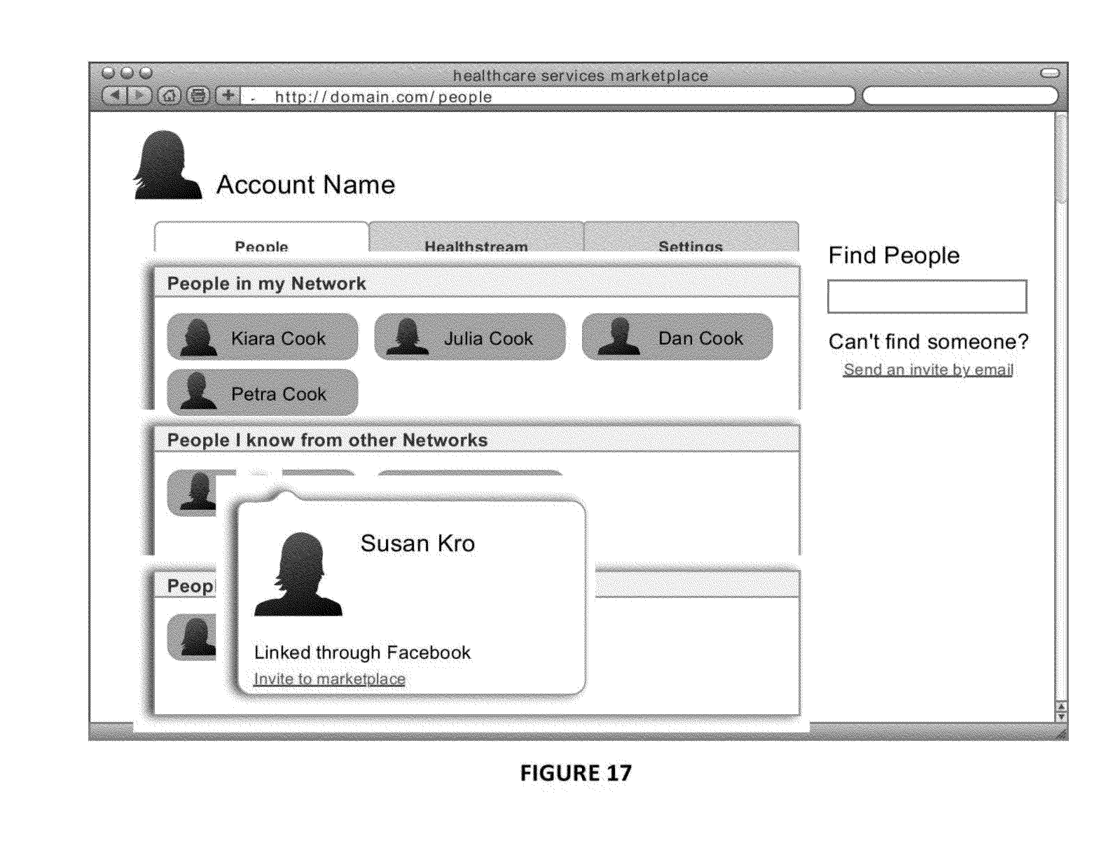

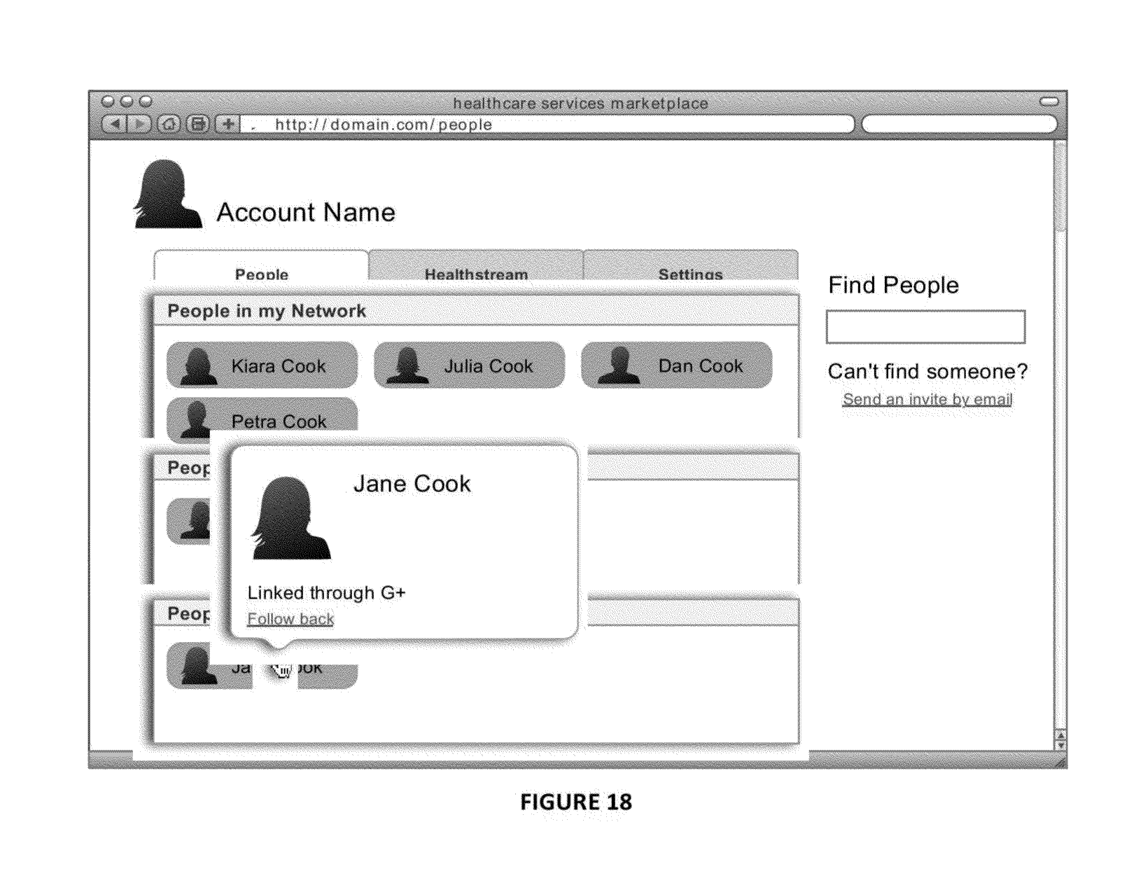

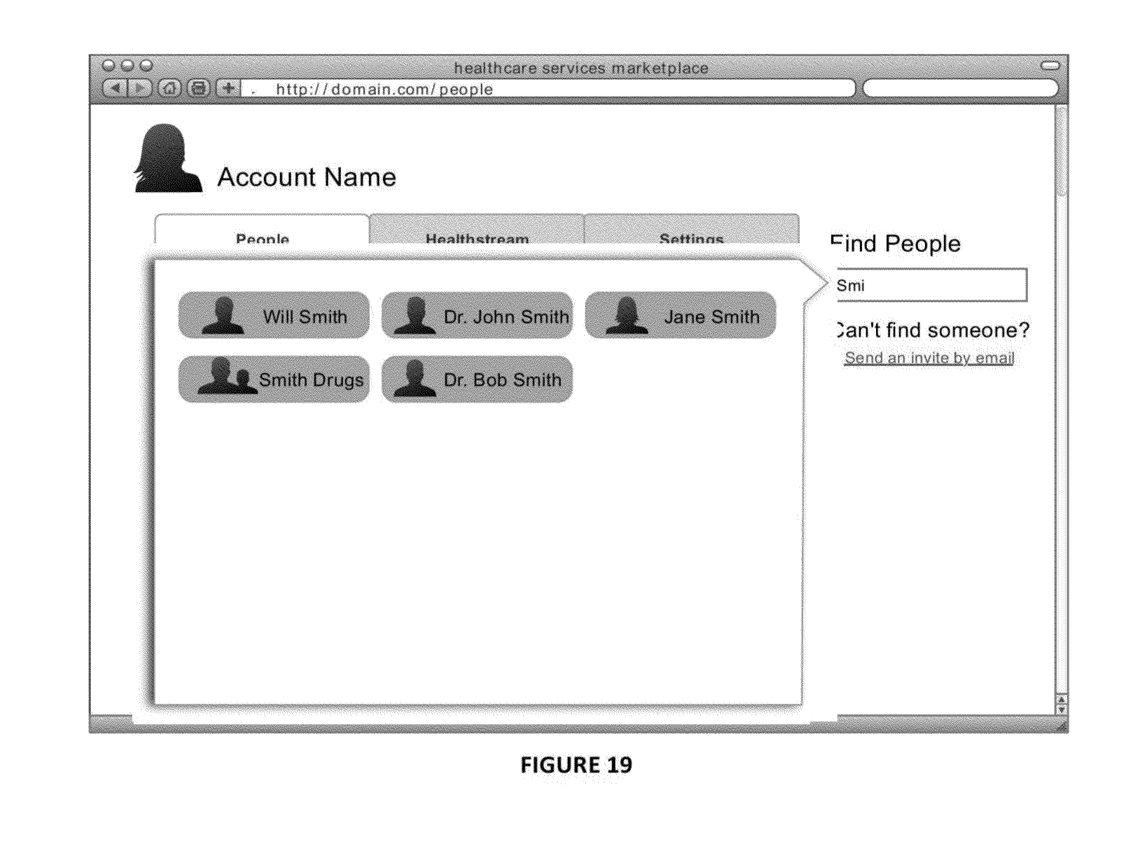

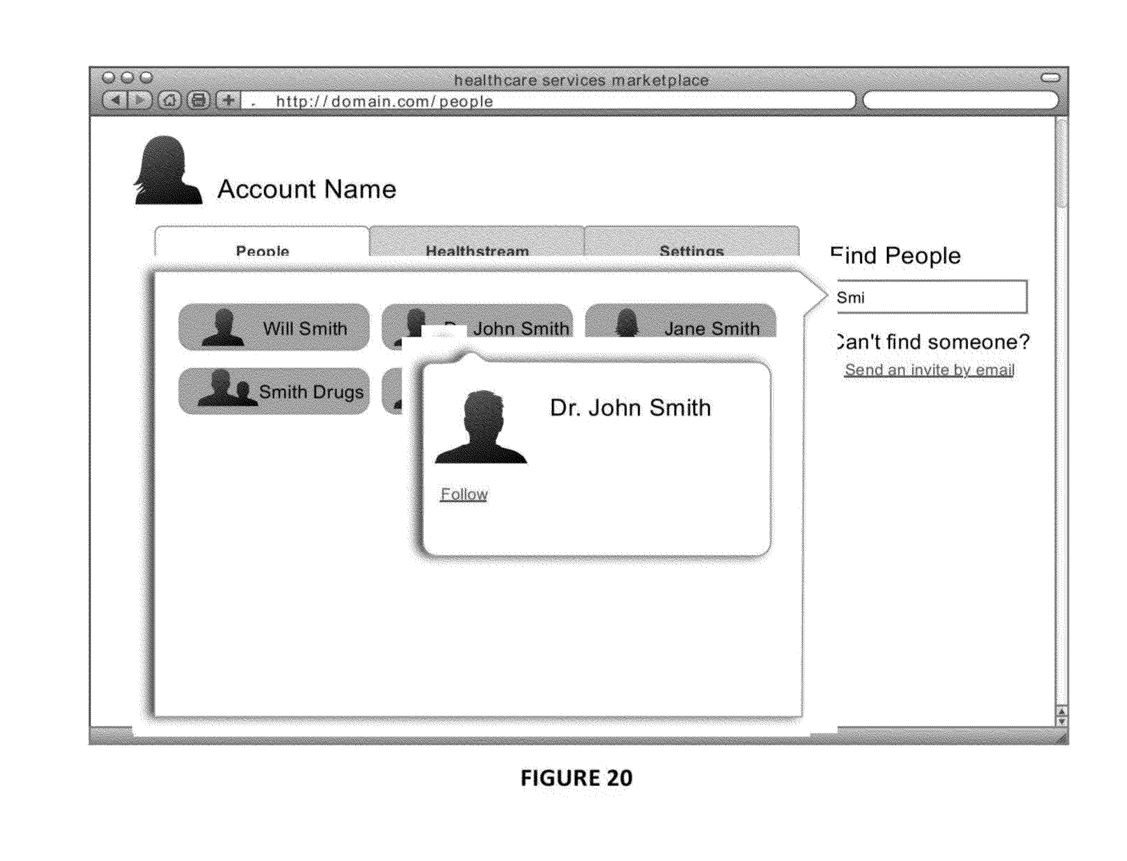

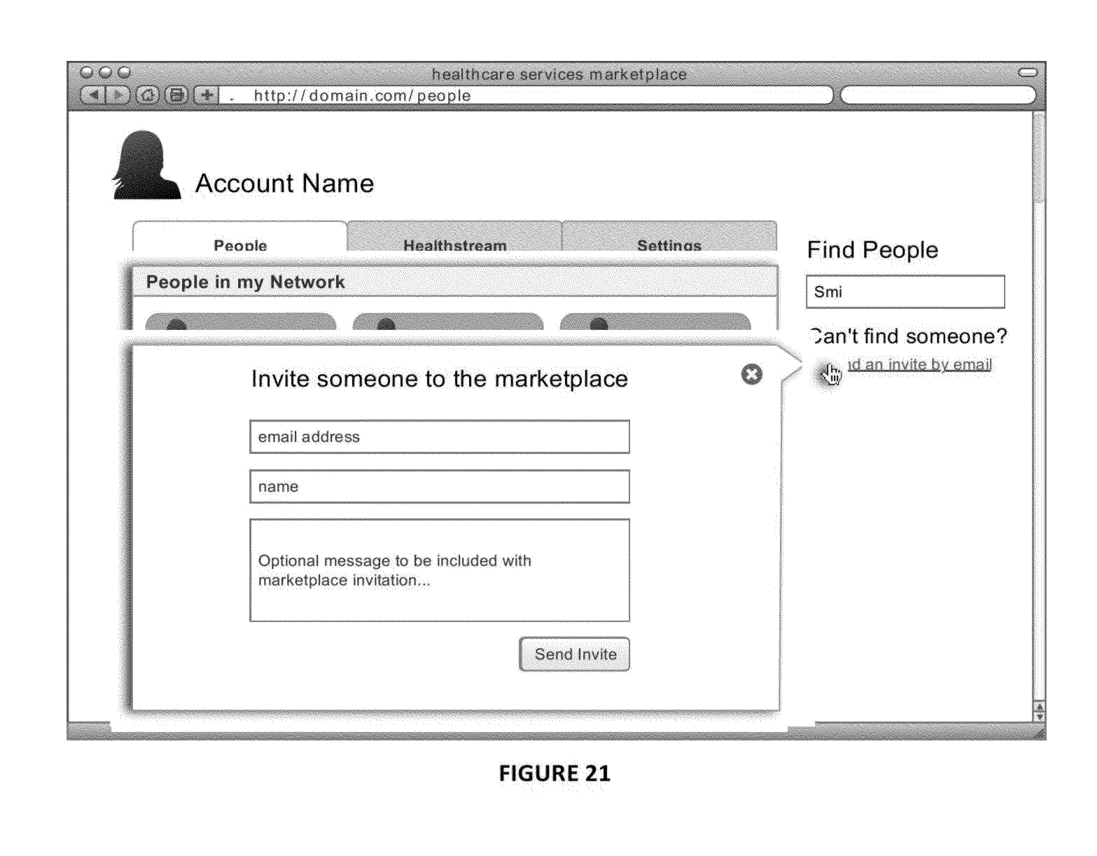

FIG. 15 illustrates an example of a find people view user interface of the healthcare services marketplace system and FIGS. 16-18 illustrate an example of a people detail view user interface of the healthcare services marketplace system. These user interfaces allows the user of the system to interact with each other, such as for example, people following other users of the system. FIGS. 19-20 illustrate an example of a people find user interface of the healthcare services marketplace system that allows a user to search for other users of the system. FIG. 21 illustrates an example of an email view invite user interface of the healthcare services marketplace system.

FIG. 22 illustrates an example of a latest services user interface of the healthcare services marketplace system and FIG. 23 illustrates an example of a service detail user interface of the healthcare services marketplace system. These user interfaces allow the user to see healthcare services that are in the system and offered to the user of the system.

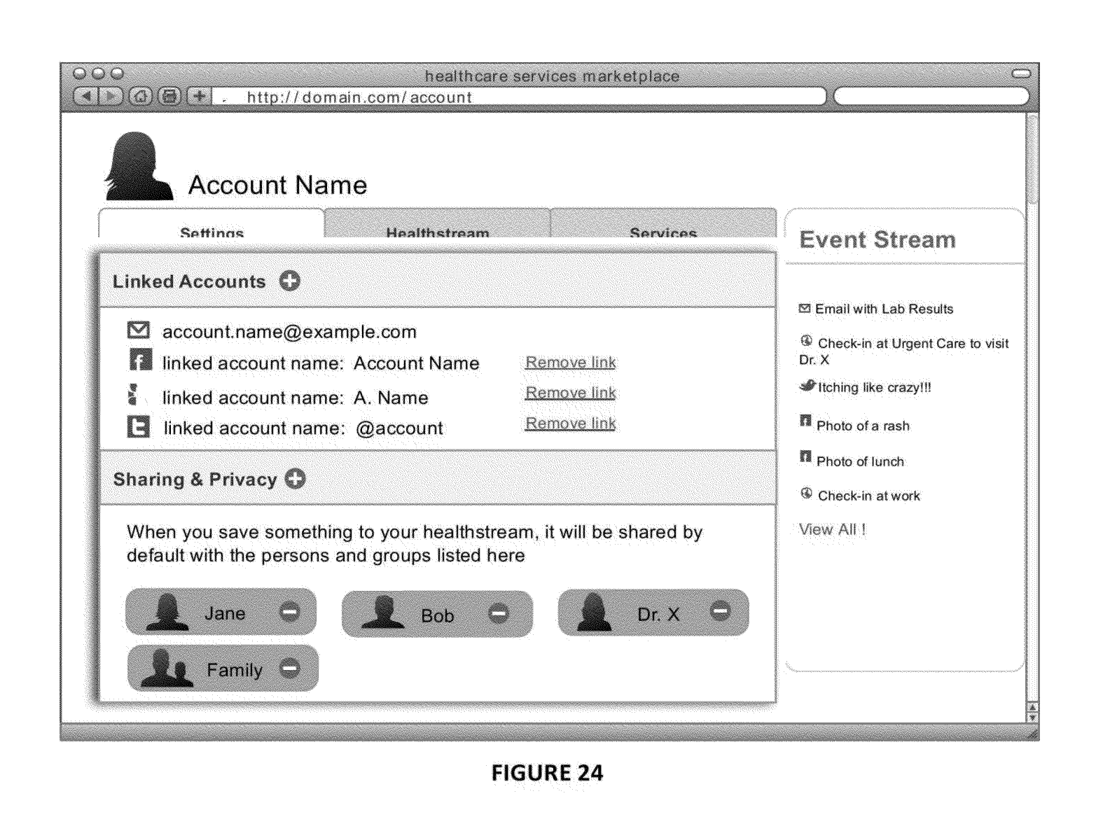

FIG. 24 illustrates an example of a general settings user interface of the healthcare services marketplace system. The user interface allows the user to set the level of sharing for each user of the system. Linked accounts that are used to automatically import healthstream entries are also managed via this user interface.

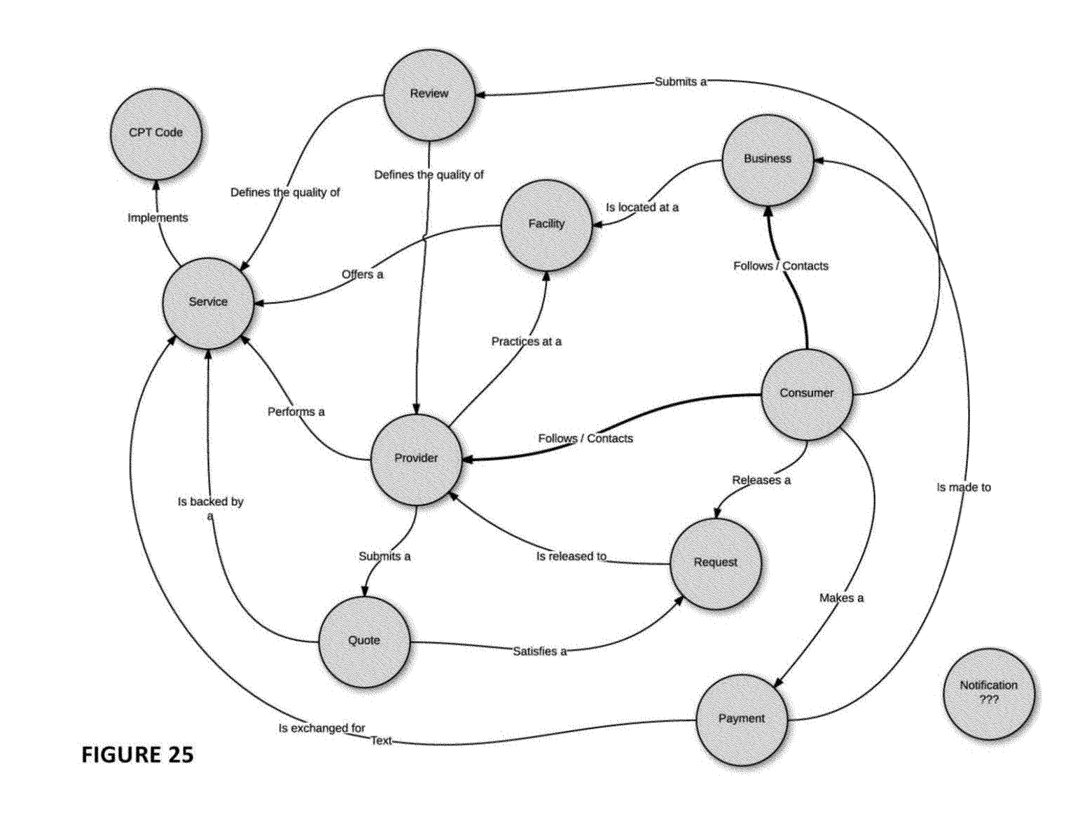

FIG. 25 illustrates an example of a database schema for the healthcare services marketplace system. As shown, the system may have one or more data items (such as quote, service, consumer, business, etc.) shown as circles in FIG. 25 that are related to each other as shown by the arrows that list a relationship, such as “defines a quality of” or “performs a”, etc.

and the direction of that relationship. The database schema shown in FIG. 25 allows the system to provide the various functions described above.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A system, comprising:
a health care management computer system having a processor;
the processor configured to generate a healthstream for each user of the system, wherein the healthstream of the user is sharable with one or more members of the system and the healthstream having a plurality of pieces of health related data about the user;
the processor configured to link an account on a third party system with the health care management computer system and to use an application programming interface of the linked third party system to import health related data into the healthstream of the user; and
the processor configured to generate the healthstream for the user based on health related data input by the user and the imported health related data.

2. The system of claim 1, wherein the processor is configured to link the account to the health care management computer system using an OAuth authorization process.

3. The system of claim 1, wherein the processor is configured to share the healthstream of the user based on an access level assigned to each piece of health related data.

4. The system of claim 3, wherein the one or more members of the system are one or more healthcare providers for the user and a family of the user.

5. The system of claim 1, wherein the processor is configured to drag and drop a piece of health related data into the healthstream.

6. The system of claim 4, wherein the processor is configured to alert the healthcare provider when a new piece of health related data is in the healthstream.

7. The system of claim 6, wherein the alert is one of an email message and an SMS message.

8. The system of claim 1, wherein the healthstream for the user has a plurality of cases within the healthstream.

9. The system of claim 8, wherein the plurality of cases are a healthstream for a plurality of members of a family.

10. The system of claim 1, wherein the health related data is one of a check-in event, a photo, a medication of the user, an office visit event and a video.

11. The system of claim 10, wherein the check-in event further comprises a link to a location of the check-in event.

12. The system of claim 10, wherein the photo further comprises an original phone and one or more cached versions of the photo at different resolutions.

13. The system of claim 10, wherein the medication further comprises a start and stop time of the medication and a dosage level for the medication.

14. The system of claim 1, wherein the processor is configured to display a timeline user interface based on the healthstream of the user.

15. The system of claim 1 further comprising one or more computing devices wherein each computing device couples to an interacts with the health care management computer system.

16. A method, comprising:
providing a health care management computer system having a processor;
generating, by the processor, a healthstream for each user of the system, wherein the healthstream of the user is sharable with one or more members of the system and the healthstream having a plurality of pieces of health related data about the user;
linking, by the processor, an account on a third party system with the health care management computer system;
importing, using an application programming interface of the linked third party system, health related data into the healthstream of the user; and
generating, by the processor, the healthstream for the user based on health related data input by the user and the imported health related data.

17. The method of claim 16, wherein linking the account to the health care management computer system further comprising using an OAuth authorization process.

18. The method of claim 16, wherein sharing the healthstream of the user further comprises sharing the healthstream of the user based on an access level assigned to each piece of health related data.

19. The method of claim 18, wherein the one or more members of the system are one or more healthcare providers for the user and a family of the user.

20. The method of claim 19 further comprising alerting the healthcare provider when a new piece of health related data is in the healthstream.

21. The method of claim 20, wherein the alert is one of an email message and an SMS message.

22. The method of claim 16, wherein the healthstream for the user has a plurality of cases within the healthstream.

23. The method of claim 22, wherein the plurality of cases are a healthstream for a plurality of members of a family.

24. The method of claim 16, wherein the health related data is one of a check-in event, a photo, a medication of the user, an office visit event and a video.

25. The method of claim 24, wherein the check-in event further comprises a link to a location of the check-in event.

26. The method of claim 24, wherein the photo further comprises an original phone and one or more cached versions of the photo at different resolutions.

27. The method of claim 24, wherein the medication further comprises a start and stop time of the medication and a dosage level for the medication.

28. The method of claim 16 further comprising displaying a timeline user interface based on the healthstream of the user.

29. An apparatus, comprising:
a memory storing a healthstream of a user;
the healthstream having:
one or more pieces of health related information about the user entered by a computing device of the user; and
one or more pieces of health related information about the user from one or more third party systems.

30. The apparatus of claim 29, wherein the one or more third party systems further comprises one of a social networking system, a messaging system and a system having a check-in.

31. The apparatus of claim 29, wherein the health related data is one of a check-in event, a photo, a medication of the user, an office visit event and a video.

32. The apparatus of claim 31, wherein the check-in event further comprises a link to a location of the check-in event.

33. The apparatus of claim 31, wherein the photo further comprises an original phone and one or more cached versions of the photo at different resolutions.

34. The apparatus of claim 31, wherein the medication further comprises a start and stop time of the medication and a dosage level for the medication.
